(19) United States
(12) Patent Application Publication
(10) Pub. No.: US 2010/0062134 A1
(43) Pub. Date: Mar. 11, 2010

(54) Alcohol based frozen dessert product

(76) Inventors: David Hart Melvin, Toronto (CA); John David Irvine, Oakville (CA)

Correspondence Address: Bodner & O'Rourke, 425 Broadhollow Road, Melville, NY, 11747, US

(21) Appl. No.: 12/584,069

(22) Filed: Aug. 28, 2009

Related U.S. Application Data
(63) Continuation-in-part of application No. 10/787,253, filed on Feb. 26, 2004.
(60) Provisional application No. 61/190,409, filed on Aug. 28, 2008.

(51) Int. Cl. A23G 3/50; A23L 1/236; C12G 3/14; A23G 3/36; F25C 1/00

(52) U.S. Cl. 426/548; 426/592; 62/66

(57) ABSTRACT

The present invention is directed to a single phase alcohol based frozen product. The single phase product is manufactured by introducing a premix, which includes alcohol, into a body of cryogen which freezes the premix rapidly. The single phased product does not include any liquid or gaseous components. The invention elevates the melting and fusing temperature of the pellets such that the storage temperatures of the pellets are similar to bulk frozen desserts. The invention may utilize the ingredients of bulk frozen desserts with the addition of alcohol. The invention is stable at retail and home freezer situations. The formulation and manufacture of the single phase product is different from bulk frozen desserts as well as other alcohol containing frozen products. The result is a product that maintains the desired individuality of the pellets while maintaining structure, such that fusing is inhibited at the storage and serving temperature.

This application claims priority on U.S. Provisional Patent application Ser. No. 61/190,409 filed Aug. 28, 2009 the disclosure of which is incorporated herein by reference. This is a continuation in part of U.S. patent Ser. No. 10/787,253 filed Feb. 26, 2004, the disclosures of which are incorporated herein by reference.

### FIELD OF THE INVENTION

The present invention relates to frozen products and, more particularly, frozen beverage products. More specifically the invention relates to a single phased frozen beverage type product formed from an alcohol based liquid. This invention further relates to a single phased pelletized frozen alcohol based dessert product made from a premix that can be stored and consumed at regular frozen dessert temperatures while still maintaining a single phase pellet that does not agglomerate at home based and commercial freezers.

### BACKGROUND OF THE INVENTION

Frozen dessert products are very popular. Ice cream and ice milk products are particularly popular with the general public. A pelletized frozen dessert product that is similar in flavor to a bulk frozen dessert product has entered the specialty market in recent years. Unfortunately, this product requires that the storage temperature for any period of time must be below about −34 to −40 degrees Celsius for optimal taste, storage, dispensing, and to remain in a single phase. Consequently, the storage demands of storing the frozen pellet in the range of about −34 to about −40 degrees Celsius has limited the distribution and market of this dessert product substantially.

The pelletized frozen dessert product although generally similar in taste to its comparable bulk frozen dessert is a unique product with its own particular characteristics. This frozen pellet can be manufactured utilizing existing premixes that are utilized in the bulk products, however it results in storage demands that require extreme storage conditions in order to maintain the unique physical structure of the product.

The present invention produces a single phase pelletized frozen dessert product and provides a premix which includes alcohol or alcohol based product and an alteration methodology such that the frozen pellet can be stored in the storage conditions utilized for storage in the bulk frozen dessert market. A single phase frozen dessert product is a term that refers to a homogeneously frozen solid created from a pre-mixed fluid frozen very rapidly in a cryogen in small volumes and hence remain in the same homogeneous state as they were in the liquid pre-mix. The product formed by the freezing step is a single phase product i.e. a solid pellet that does not include any liquid, or gaseous components that have been inserted into the premix or is otherwise included in the premix by the formation process. The small volume of the pre-mix and rapid freezing rate cause the product to consist of exclusively of pre-mix, excluding air and liquid as in regular frozen dessert products.

The single phase pelletized frozen dessert product of the present invention can be introduced into the general retail market without the necessity for specialized storage and shipping equipment or trained staff for distribution to the public.

### PRIOR ART DESSERT TYPE PRODUCTS

In order to properly understand the uniqueness of the patent a description of existing bulk frozen dessert and pelletized frozen dessert type products and their manufacture and storage and structure of the served product is presented.

Bulk frozen dessert products are manufactured utilizing a liquid pre-mix. The particular pre-mixes have evolved to produce frozen products that meet the needs and demands of the market. These needs and demands are flavor and sweetness and creamy structure and the ability to be scooped and served within the temperature ranges of commercial and home freezer storage systems.

Flavors of frozen desserts range from the traditional flavors such as vanilla, chocolate and strawberry to a complex mix of different cookies and other ingredients as well as different fruit and other flavors. All flavors however, need to have the basic structure that makes them a frozen dessert.

The market basically expects a product with a familiar level of sweetness. In a bulk product the sweetness is partly a result of the need to add an ingredient to the pre-mix that alters the freezing point such that the desired structure and texture is obtained.

The structure is such that the served product must be soft enough that it is consumable with a fork or is capable of being scooped into a cone or other holder. This demands that the served product be soft enough to be eaten pleasantly at the required serving temperature of around −12° C. to −8° C.

The simplified process of manufacture is as follows. The pre-mix goes into a freezing barrel. When the pre-mix is in contact with the surface of the freezer barrel the premix starts to freeze. The freezing mix is removed from the cooling surface via a moving blade or paddle that mixes the frozen mix with the unfrozen mix. The process continues by mixing the freshly frozen pre-mix, with the remaining premix until a semi-frozen product results. As more of the mix freezes, the freezing point of the mix that remains in a liquid form lowers to a point where no more ice can be formed. The product at this point is about the consistency of soft ice cream.

A more complex description is as follows. Inside the freezing cylinder the liquid mix, with its suspended fat globules and colloidal proteins and carbohydrates and salts, is transformed into a highly viscous “foam”,

Ice crystallizes from the continuous phase, transforming it into a thick syrup. Air cells form, and hydrophilic colloids absorb to their surfaces, stabilizing them. Air cells are essential in conventional bulk ice cream products because they create overrun, which refers to the increase in volume of the ice cream over the volume of the mix used. Air cells also affect the overall taste of the ice cream, as well as scoopability. The additional considerations of taste and scoopability that air cells create in bulk ice cream products results in added production costs as well. Fat globules become increasingly crystalline, and some of them coalesce, forming structure that supports the foam. As the product exits the freezer, it has about one half of its water frozen and has expanded up to about 100% in volume. The continuous phase is a thick syrup while the disperse consists of air cells and ice crystals and fat globules and casein micelles and other hydrocolloids. This makes ice cream a three-phase system: gaseous and solid and liquid. The agglomeration is a combination of small ice crystals and concentrated small pockets of unfrozen pre-mix and air. The concentrated pockets of premix are mostly a result of the freezing process concentrating the liquid such that its freezing point is further depressed.

The product is then removed and poured into bulk containers of the desired end size. The temperature is lowered such that the bulk product evolves to the solid frozen bulk. The product is stored at a recommended commercial temperature of from about −20 to −25 degrees Celsius, however, it can be stored at temperatures below that if the equipment is available.

When a bulk product is ready to be consumed it is tempered (warmed up) such that it again becomes smooth and creamy. This enables it to be scooped for cones, on pies etc. The ideal texture of a frozen dessert is a soft and creamy product that will stick together effectively.

At serving temperature the product is actually only about 50% to 70% frozen. The frozen aspects of the dessert create sufficient stability such that the remainder of the mix is held in place. Very much like mayonnaise holding its ingredients in a mix. The key part of this description is that the pre-mixes utilized for regular frozen desserts are about 80% frozen at recommended serving temperatures. The temperature of the dessert is from about −6 to about −10 degrees Celsius.

This is about the average temperature of a freezer connected to a fridge. Longer term storage in equipment such as a deep freezer or a commercial deep freezer results in a higher percentage of the dessert being frozen resulting in the characteristic spoon bending hardness of ice cream from the deep freeze.

The mixture also has air trapped in its texture; this can be significant with as much if not more than 50% of the volume of the finished product is air. The air will create a certain amount of product insulation such that it will inhibit heat transfer between the bulk of the frozen dessert and the ambient environment.

### Single Phase Frozen Dessert Pellets

The single phase frozen dessert pellet is a unique product with its own particular characteristics, however the pre-mix historically utilized has been virtually the same as that utilized in a bulk frozen product. This has resulted in the requirement for the pellet to be stored and served at very low temperatures i.e., about −28.8 C. for short term storage, about −34 C. to about −40 C. for general storage and about −23 C. to about −28.8 C. for serving/consuming.

The pre-mix is introduced into a body of liquid cryogen (such as liquid nitrogen) as a series of small volumes of liquid (droplets). As a result of the significant difference in temperature the process of freezing is extremely rapid.

Unlike ice cream that is a three-phase product a frozen dessert pellet is completely frozen virtually immediately. This results in the finished product leaving the cryogen being completely or virtually solid and in a single phase.

The pellet exits the process in completely or virtually a single phase, solid. When it is tempered it all melts at basically the same rate, as it was never differentiated into frozen aspect and a syrup phase when processed.

The liquid pre-mix is introduced into the body of a liquid cryogen as a small droplet. Upon entering the liquid cryogen, a crust or hard outer layer is immediately formed around the droplet. Freezing of the core is very rapid resulting in very small or virtually non existent ice crystals being formed. Depending upon the management of the liquid cryogen the pre-mix droplets can be formed into pellets with the following general characteristics: 1. The pre-mix will form a percentage of hollow shells with the contents freezing as new and smaller droplets. 2. A popcorn type product, which is basically the frozen explosion of the pellet. 3. Well formed, basically spherical in nature. 4. Random shapes, with the pellets being in various sizes, mostly as a result of post introduction fusing of forming pellets.

Since the freezing process is significantly different 1. The pellets do not have any air incorporated within its solid structure in the processing. This results in a frozen product that is 100% pre-mix. 2. There aren't any pockets of concentrated liquids and syrups with different freezing points within the structure of the solidified pellet. 3. The pellet is 100% frozen, and cannot be scoped and served like conventional ice cream products. 4. The pellet is only in a single phase, that phase being solid.

The frozen pellet is simply, frozen pre-mix without the effects of the freezing and mixing process associated with the freezer barrel utilized for a bulk frozen dessert. It is a single phase product and does not have the three phase (solid, liquid, and gaseous states) and agglomerated structure of a bulk frozen dessert product.

As a result of the rapid freezing the pellet maintains the original ingredient flavors to a much greater extent.

When the pellet exits the processing system, the temperature of the product is at temperatures ranging usually from about −40 to about −60 degrees Celsius to very much colder. This exit temperature is partially dependent upon the process and management and retention time in the liquid nitrogen and the average size of the pellet. The physical appearance and structure of the product can be controlled to vary from a popcorn type product to a hollow sphere to a well formed sphere to random shapes. This is a function of the management of the Liquid Cryogen and the equipment.

After processing the finished product is sent to a storage system that is in general much warmer relative to the finished product. The pellets are usually in the range of about −60 Celsius and colder, while the standard storage temperature for bulk desserts is typically from about −25 degrees Celsius to about −40 degrees Celsius.

A finished pellet can be poured or handled as one would handle ball bearings or other generally small round solids, and do not have to be scooped like conventional ice cream products.

The total surface area, on per volume of premix utilized, is understandably much larger in surface area than a comparable amount of pre-mix utilized in a bulk product. The pellet is kept at the 100% solid state or very close to this single phase existence in order to maintain its structural integrity. When tempering occurs it occurs at a rather rapid rate as a result of its high surface area per unit of weight.

Once the pellet starts to melt, it immediately will stick to associated pellets resulting in fusing of the pellets into a mass or the complete loss of the pellet type structure.

Historically the required storage temperature has been required to be approximately about −34 to −40 degrees Celsius in order to keep it in a single phase and prevent the fusing of pellets.

Specialized vending equipment and delivery systems have been developed in order to handle the product and hold it at these cold temperatures.

In order to prepare the product for serving tempering (warming up) is required. In spite of the fact that there aren't any regulations regarding the minimum temperatures that food can be offered to the public good practice dictates that food at about −34 to −40 Celsius cannot be given to a person to eat. If a food product is placed in a mouth at these temperatures cellular damage to the mouth can occur. The reason there is not a minimum temperature regulation is that food in general is not consumable at these cold temperatures. At these cold temperatures food is structurally very solid and cannot be scooped or bitten or chewed. So it is likely that the necessity for a regulation never existed.

The frozen dessert pellet because of its individual small size can be put in a mouth at any temperature. A pellet at about −34 to −40 Celsius or lower can be put into a mouth easily. At colder temperatures the cellular damage can just be worse.

Since there does not seem to be any guidelines as to the lowest legal temperature that food can be served, safety is left as a decision to the distribution company. The result is that trained staff is required to interact with the public.

The requirement of storing the pellets at these low temperatures limits their distribution and demands that it must be only handled for serving by trained staff.

As can be seen there are significant differences that exist between the frozen pellet and its comparable bulk frozen product. 1. The pellet has a higher density resulting from being 100% pre-mix. 2. The surface area on a per volume of premix basis is much higher in the pellet. 3. A given volume of frozen pre-mix will temper much more rapidly. 4. The pellet is in a single phase which is the solid phase. 5. Flavors will be better preserved. 6. The range of consumable temperatures is small. 7. The pellet must be tempered by trained staff. 8. The pellet must be maintained at temperatures close to about −34 to −40 degrees Celsius in order to maintain its structural integrity 9. The pellet does not contain air or fat globules.

The lack of air in the single phase frozen dessert product is a significant difference between the present invention and conventional bulk ice cream products. It is well known by those skilled in the art that air is a critical ingredient to bulk ice cream. In addition to overrun, the presence of air also affects the final flavor of the ice cream. Thus, a premix for a bulk ice cream product which uses the presence of air cannot be used to make a single phased frozen dessert product without significant modification because the intended flavor would be different.

A pelletized frozen dessert is a unique product with the differences between the comparable bulk frozen dessert and a frozen pelletized dessert being significant.

Historically, a similar premix to a bulk product has been utilized for a pelletized frozen dessert type product. This demanded that in order to account for the many differences previously described the pellet had to be stored and handled at depressed temperatures.

A bulk product is in 3 phases with it being a consumable product at about −6 to −10 degrees Celsius. As the temperature of a bulk product increases percentages of the agglomeration change from a solid phase to a liquid phase. The bulk product melts in the same ratios as it was frozen. The pellet, since it solidified immediately its frozen matrix will melt very much like a small chips of ice will melt.

In the area of frozen dessert products there has been a great deal of interest in the sale of frozen pellets. One company selling such frozen pellets is Dippin Dots these pellets do not include alcohol. The Dippin Dots product is a pelletized ice cream product that is made by dropping drops of a standard commercial three phase hard ice cream mix into a liquid nitrogen bath. One of the problems with the Dippin Dots product is the very low storage temperatures that are required to keep the product as a discrete pellet. The Dippin Dots product typically requires a storage temperature of about −34° to about −40° C. for optimal taste, storage and dispensing. One of the problems with the low temperature requirement of a prior art type product has been the low storage temperatures required. Ice cream products have a better taste as the temperatures approach 0° C. (32° F.) Thus, very hard ice cream does not taste as good as a softer hard ice cream. As a result, a product stored at temperatures below −34° C. will not usually have the same taste as a product dispensed at a higher temperature. In the Dippin Dots type product if these low temperatures are not met, there is a significant risk of product agglomeration where the pellets become an indistinct mass of product. Thus, the mass of the product loses its pellet attributes. In order to keep the Dippin Dots product in the form of individual pellets, they must be stored at significantly lower i.e. colder temperatures than the traditional ice cream products. This low temperature storage can require significant investment for many potential customers and makes the product much more difficult to ship economically.

The difficulty of the prior art pellets is solved by the invention of U.S. patent application Ser. No. 10/787,253, filed Feb. 26, 2004. This patent application discloses a pre-mix composition suitable for making a single phase pelletizing product that can be stored and transported in conventional equipment used for traditional ice cream products not specialized storage equipment for low temperature storage. In addition, as noted above the properties of alcohol-water solutions as their temperature lowers increases the possibility of separation of the individual components.

What occurs with the present premixes utilized for this type of product is that the pellet must be stored at temperatures close to about −34 to −40 degrees Celsius to maintain a single phase. The pellet is served at as cold a temperature as possible without hopefully causing cellular damage in the mouth.

This cold serving temperature inhibits the flavor of the product. The tempering that is essential in advance of serving demands trained serving staff. These restrictions on the handling and serving the product has resulted in severely inhibiting the availability of the product to the general public. Availability has only been typically at special events or via trained serving staff.

Commercial storage facilities at about −34 to −40 degrees Celsius are limited. Applicant is unaware of commercially available trucks that can move a product at about −34 to −40 degrees Celsius. In store facilities available to the public at about −34 to −40 degrees Celsius are virtually non-existent. In addition −34 to −40 degrees Celsius storage demands expensive equipment and high running costs because ice cream generally spends typically 2 weeks in the warehouse freezer at the manufacturing plant, 4 weeks in the freezer at a distribution center, and sometimes 4 weeks at a retail outlet before it is sold and consumed.

In order to introduce the small individual frozen dessert pellet to the existing market infrastructure it was essential to invent a premix that allows the pellet to exist in a single phase near the temperatures utilized in the storage of bulk frozen dessert products.

The solution is to alter the premix formulation such that the pellet is in a single phase at a range of temperatures near the standard commercial storage of bulk ice cream products.

### Alcohol Based Products

Most ice cream and other frozen dessert products have little if any alcohol present. While alcoholic beverages are also popular, the extremely low freezing point of alcohol makes alcohol difficult to use in a frozen product. One type of product that has been available for a number of years has been a gelatin based alcohol containing product. One colloquial identification for such a product is “Jello shots.” Jello shots are made from a gelatin based product where alcohol is used as a solvent. The gelatin forms a semisolid gel complex as it solidifies encapsulating the alcohol contained therein. A Jello shot type product however is a gel and is not a single phase product.

Ethanol, the alcohol used in alcoholic beverages, has a melting point of −114° C. (−173° F.). This is one reason many thermometers use an alcohol based material. Even at low temperatures the material remains an unfrozen liquid and than can be used in most physical environments on earth. Water freezes as 0° C. (32° F.) and the coldest home freezers typically will not go below about −18° C. Because of its low freezing temperatures, an alcohol based product is very difficult to freeze and keep frozen.

Most alcoholic based products such as scotch, rye, rum, vodka, etc., are not pure ethanol. Alcohol based products such as rye, scotch, gin, rum, etc. identify the percentage of alcohol by the description “proof” Thus a 100 proof product is 50% alcohol. Many hard liquors are 40 proof or higher but not usually going above 100 proof Beer and wine usually have a much lower percentage of alcohol usually well under 20%. The largest percent of ingredient in a liquor beer or wine is water.

Because most alcohol based beverages have a significant amount of water present the freezing point for these beverages is not as low as for pure alcohol. As little as 1% alcohol in water will lower the freezing point of water. The higher the concentration of alcohol, the lower the freezing point. Thus, for example, 1% alcohol in water will have a freezing point of a little less than 0° C. Ninety-five percent alcohol will freeze fairly close to −114° C.

Although alcohol lowers the freezing temperature of water, the two liquids do not freeze in unison. As the water in a water alcohol mixture begins to freeze, the water soluble alcohol forms hydrogen bonds with the water. The presence of the alcohol/water hydrogen bonds interferes with the structure of the lattice formed by ice thereby depressing the water's freezing point. As the water temperature is reduced, alcohol is forced out of the lattice formed by freezing ice just as salts and other solutes are. This property of water-alcohol mixes has been used to increase the alcohol content of some fermented beverages. For example, partially freezing hard cider and straining off the ice crystals leaves behind a more potent residue call “apple jack.” This process is called fractional freezing.

One of the problems with attempting to make frozen pellets of alcohol based products is the lower storage temperatures required to keep the product in discrete pellets. Alcohol based pellets typically need to be frozen at lower temperatures than ice cream based pellets. In addition, they typically need to be stored at significantly lower temperatures.

### OBJECTS OF THE INVENTION

It is an object of the invention to provide an alcohol based solid single phase frozen product that may be stored as discrete pellets in conventional ice cream storage equipment.

It is another object of the invention to provide an alcohol based pre-mix that will form frozen single phase pellets that may be stored for significant periods of time as discrete individual pellets at temperatures as high as −12.22° C.

It is another object of the invention to provide an alcohol based frozen type single phase product that may be served as individual pellets for a short period of time at temperatures above freezing point of water.

It is a further object of the invention to produce a frozen pellet that would approximate the composition of a mixed drink.

It is a further object of the invention to produce a frozen pellet that would approximate the taste of a mixed drink.

It is a still further object of the invention to provide a premix that may be used to form a frozen alcohol based single phase pellet.

It is a still another object of the invention to provide a premix that may be used to form a frozen alcohol containing single phase pellet.

### SUMMARY OF THE INVENTION

The present invention is directed to an improved single phase alcohol based frozen dessert pellet that can remain in a single phase using the existing storage and handling facilities presently utilized for bulk frozen dessert products. In order to achieve this, an improved premix has been developed. The frozen pellets made from the premix of the present invention have the following characteristics:

1. The pellet is preferably a solid between about −15 and about −25 degrees Celsius.

2. The pellet softens on melting and does not melt like an ice chip.

3. The melting point of the pellet is preferably approximately −6 to −15 degrees Celsius.

4. There is also inhibition of fusing of pellets once melting temperature is initiated.

The present invention is directed to a superior premix utilized in a alcohol based frozen dessert product. The unique premix raises the freezing point of the premix which subsequently raises the melting point of the frozen premix. In addition the additives that are included inhibit the undesirable structural breakdown of the pellet once melting or softening of the pellet is initiated.

The present invention is directed to a frozen, alcohol based product that is a solid single phase product that is a solid single phase product. The product of the present invention is alcohol-containing frozen pellets. The frozen pellets of the present invention remain as discrete pellets and do not agglomerate into clumps at storage temperatures as high as −10° C. and even higher. The composition of the present invention includes an alcohol such as an alcohol based product, a water based mixer and one or more stabilizers. The alcohol based product can be ethanol or any suitable alcoholic beverage such as a liquor, a beer or a wine. In one embodiment the alcohol based product can be a mixed drink, having an alcohol and a water based mix. Suitable alcohol based products include but are not limited to scotch, rye, vodka, gin, rum, etc. Alcohol based beverages include, but are not limited to, gin and tonic, rum and Coke, scotch and soda, rye and ginger, margaritas, Tom Collins, etc. The composition of the present invention can include beer, wine and liqueurs, as well.

The stabilizer used in the present invention may include, but is not limited to, guar gum, sodium alginate, carob bean gum, agar, etc. The stabilizer provides solid content and binding capabilities to the composition. The stabilizer helps prevent the alcohol and water from separating as the temperature of the composition is lowered during freezing.

The product of the present invention is formed by blending the alcohol or alcohol based product with a water based mixer and the stabilizer. Small droplets of the composition are dripped into a liquid nitrogen bath where the droplets are frozen into discrete pellets. The frozen pellets are removed from the bath. There are many ways of forming the pellets of the composition of the present invention. One such process is shown in U.S. Pat. No. 7,062,924, the disclosures of which are incorporated herein by reference. Another approach is shown in U.S. Pat. No. 4,482,577, the disclosures of which are incorporated herein by reference.

The invention is also directed towards an alcohol based frozen dessert pellet made from the premix that can be stored in conventional commercial facilities at the temperature ranges utilized for bulk frozen dessert products, i.e., being approximately −20 to −30 degrees Celsius and maintain a single phase. The storage temperature of the pellets made from the present invention is significantly higher than the storage temperature of prior art pellets made in cryogenic apparatus. In addition, the invention results in a pelletized frozen dessert product that can be stored at the temperatures of a home deep freezer being from about −15 to −23 degrees Celsius and the home fridge type freezer of about −6 to −15 degrees Celsius.

The pelletized frozen dessert product will remain in a single phase for a range at these storage temperatures.

More specifically, in order to introduce pelletized frozen dessert products into the general retail market, it is essential that the product quality and unique features be maintained within the existing storage, distribution and serving temperatures utilized for bulk frozen dessert products, that are standard to the industry. In addition the product must maintain its unique features in the frozen storage systems that exist in households.

In a preferred embodiment the present invention includes a composition that can remain frozen and in a single phase at the following temperatures:
1. Commercial refer freezer truck temperatures ranging from about −18 to −25 degrees Celsius.
2. Commercial ice cream freezer trucks ranging from about −26 to −33 degrees Celsius.
3. Commercial freezers in warehouses utilized by commercial facilities.
4. Retail store freezers that are presently utilized to store and as point of sale freezers for bulk frozen desserts. This temperature range being generally from about −25 to −35 degrees Celsius.
5. Home deep freezers systems being in the range of about −15 to −23 degrees Celsius.
6. The home freezer associated with a fridge. This temperature range being generally from about −6 to −15 degrees Celsius.

It will be generally understood that freezers used to store ice cream operate at a plurality of temperatures, and someone of ordinary skill in the art would be able to modify the present invention so that the pellet remains frozen and in a single phase at a temperature of at least two to three degrees warmer or cooler, than the preceding temperatures listed to accommodate the operating temperature of a freezer.

The present invention relates generally to a unique formulation of premixes utilized in the manufacture of pelletized frozen dessert products that will be stable and remain in a single phase in the foregoing temperature ranges.

More specifically, the formulation of a premix, is such that the pellet is substantially the same flavor as its' comparable bulk frozen dessert.

In addition the frozen pellets will maintain the desired structure and remain in a single phase when taken home by the consumer and stored in a household fridge freezer system. Providing they are only exposed to the ambient environment in the same manner as regular bulk frozen desserts are exposed.

Although the term “freezing point” is utilized in the frozen dessert science with pelletized frozen dessert products the important temperature points are as follows.

There are two main temperature points in connection with the present invention.

1. The melting point of the pellet.

2. The fusing temperature of the pellet.

The melting point is the temperature at which the product begins to melt. The mix of solids in the pellet is basically homogeneous and is in a single phase. By single phase is meant being a homogeneously frozen solid in which the pre-mixed fluids are frozen very rapidly in a cryogen in small volumes and hence remain in the same homogeneous state as they were in the liquid pre-mix. The bulk product which is in three phases and is an agglomeration has multiple melting points within its structure as each agglomerate component will have its own melting point. By three phase is meant gas, liquid and solid. Gas is the ambient air incorporated into the pre-mix as it is being frozen in a freezing barrel by the action of the paddles or blades. The liquids are those fluids that have not frozen during the slow freezing process and remain as such following said manufacturing process. The solids are those liquids that have solidified during the manufacturing/freezing process.

The temperature at which part of the single phase product initiates melting is the temperature at which virtually all of the product structure initiates melting because unlike the three phase product that melts on a gradient, the homogeneous single phase product initiates melting all at the same time because it is homogeneous and has not been differentiated or concentrated.

The fusing temperature is the temperature at which the pellet becomes sufficiently soft so that the pellet will now stick to adjacent pellets and they will stick together. The result being that the pellets start to agglomerate into a mass, thereby losing its individuality of the pellet.

Freezing point of the product is usually not a significant term in the manufacture of these frozen dessert products as the product is manufactured in a cryogen such as Liquid Nitrogen and freezing is extremely rapid with the pellet actually going into storage following the freezing process at a temperature usually much higher than when it is harvested from the freezing equipment.

Although the science refers to freezing point it is assumed that in general a freezing point is considered the same temperature as a melting point.

According to Raoult's Law, the greater the percentage of a solute in a liquid the lower the vapor pressure of the solution and the lower the freezing point of the solution. Conversely, the lower the percentage of solute in the solution the higher the vapor pressure and subsequently the higher the freezing point of the solution.

The vapor pressure of a solution is directly related to the freezing point of the product.

Thus, raising the vapor pressure of the premix subsequently raises the freezing point of the premix.

The raising of the freezing temperature of the premix subsequently raises the melting point of the pellet.

Raising the melting point of the pellet subsequently raises the fusing as well as the melting temperature point of the pellet.

The formulation of the present invention is such that the average melting temperature of the alcohol based frozen product is raised as a result of raising the vapor pressure of the premix. This results in a pellet that can be stored and served at a comparable temperature to a bulk frozen product. Those comparable products being Ice Cream, Sorbet, Water ice, Ice Milk, Frozen Yoghurt and similar type products.

The primary ingredient that alters the freezing point of a premix is the quantity of sugar in solution. Additional materials in solution also adjust the freezing point as well, however the primary freezing point altering ingredient is the sugars present. As more sugar is removed, the freezing point of the mix rises and the hardness of the product increases. In conventional low sugar frozen dessert products bulking agents such as dextrose, fructose, sucrose, lactose, maltose, honey, and corn syrup are often added to the composition of the pre-mix to lower the melting point of the product because conventional frozen dessert products require a degree of softness to be served and eaten. Within the context of this invention and the product quality desired the melting point is more important than a freezing point, however essentially these temperature are the same.

The fusing point is also a useful term in relation to this invention as the goal was to produce a frozen dessert pellet that will maintain its structural integrity when handled and served at recommended temperatures similar to those utilized for bulk frozen desserts.

Various stabilizers are added to the premix in the form of edible gums, depending upon the product being manufactured. As a result when the pellet is in the range of its melting point this causes the product to soften a little yet the pellet will continue to maintain its basic structure.

The elevation of the melting temperature and fusing point takes into account a variety of important factors.

1. The surface area of the product on a volumetric basis is substantially higher than its comparable bulk product.

2. The heat transfer within the product itself is faster as the pellet does not have the advantage of air mixed with the product to inhibit heat transfer.

3. The product although desired to be firm, must be sufficiently soft that it can be consumed as a pleasant dessert and not as a hard pellet of ice.

More specifically, to the formulation for preparing the premix of an single phase pellet type alcohol based frozen dessert product, the actual formulation will differ from product to product as flavorings, juices, amount of alcohol or liqueur and other ingredients are required. The reason for this is that all of these individual ingredients will have some effect upon the overall freezing point and subsequently upon the overall fusing and melting point of the product.

The premix alterations result in maintaining the individual pellet integrity of the pelletized frozen dessert product in a single phase for a range of the desired temperatures.

In order to manufacture any acceptable frozen dessert it demands that a certain sweetness be present in the product. A variety of sugars provide this desired sweetness by the consumer.

Additionally stabilizers in the form of edible gums are added to the premix such that upon initial melting the gums assist in stabilizing a structure and allowing it to soften a little near its melting point yet preventing it from losing its basic structure at that point.

The frozen pellet maintains its single phase and structural integrity and can be stored at a range of temperatures used to store bulk frozen desserts, that storage temperature being from about −20 degrees Celsius to −30 degrees Celsius.

The pelletized frozen dessert will maintain its single phase and structural integrity in the home deep freezer temperatures of approximately about −18 to −25 degrees Celsius.

The pelletized frozen dessert will maintain single phase and sufficient structural integrity in the home fridge freezer temperatures of about −6 to −15 degrees Celsius even though it may soften at these temperatures.

The higher melting point combined with the gum stabilizers provide a synergistic result such that the structure is enhanced providing the desired pellet that can be presented and marketed within the infrastructure that exists for marketing and distribution of bulk frozen desserts.

### DETAILED DESCRIPTION OF THE INVENTION

The present invention is directed to improved compositions that may be used for forming frozen pellets containing an alcohol or alcohol based product. The composition in its most general form includes alcohol, a water based mixer and a stabilizer. The alcohol is preferably present in an amount of up to about 40% by volume of the composition. The alcohol content refers to the total percentage of alcohol in the blend There is also a water based mixer which can be any number of materials. For example, it can be water, a diet soda or club soda. The mixer could also be a vegetable or fruit puree. The water based mixer is present in an amount of at least 60% or more by volume. In a preferred embodiment, there is a stabilizer added to the mixer/alcohol blend. The stabilizer can be a guar gum, sodium alginate, carob bean gum, agar, etc.

In a preferred embodiment, there is about 20% to about 25% by volume of alcohol where the alcohol in the composition is a liquor such as gin, rum, scotch, rye, tequila, vodka, etc. it will be appreciated that since the liquor is not pure alcohol, there is a significant amount of water in the liquor. The presence of water should be taken into consideration in preparing the composition. To the liquor is added the requisite mixer which could be the traditional blending material for the mixed drink such as a whiskey sour mix or other water based mixer. This mixer can also provide taste or flavor. Thus for a rum and Coke, there would be 20 to 25% rum and 75 to 80% Diet Coke. To this blend is added the stabilizer. The amount of alcohol in the rum will depend on the proof used.

In one embodiment of the invention there is preferably about four parts mix to one part alcohol based beverage where the total alcohol content of the blend is about 8%. In another embodiment there is above 6% alcohol. A preferred embodiment has 2 to about 20% total alcohol in the composition.

Alcohol on its own merit will not stay frozen unless held a very low temperatures (far below those of commercial or home freezers) the premise for producing a viable single phase pelletized product is to create a composition that suspends the alcohol in a solution where said solution then remains in a solidified state when held at temperatures of up to −12.22 degrees Celsius. In essence the alcohol is liquid at these temperatures but due to the suspension properties of the composition the solution itself suspends it in the solutions solidified state. The rapid, extremely deep freezing that occurs during the freezing process in a cryogen such as that utilized while doing so in a liquid nitrogen freezing process is so fast and low in temperature that cell separation and product contents separation are bypassed with the entire composition emerging in a frozen or near frozen or solidified state and exiting the cryogen at temperatures as low as minus 85.56 degrees C. (typically for standard commercial brands of alcohol based beverage containing approximately 40% alcohol they will begin to solidify and freeze at temperatures from about −100° C. and lower. Consequently this then provides for the proportions of the contents in the frozen individual volume of liquid to be the same as those of the physical proportions that were originally mixed together in a liquid state thus maintaining the original proportion targets as desired. Of note to remember is that you could not freeze this type of product any other way as the freezing process would be too slow and product separation of the different materials that make up the composition would first separate from each other with the solids migrating to the middle of the frozen mass and the alcohol essentially remaining a liquid that would migrate to the surface of the frozen mix hence rendering the mixture un-solidified in totality and disproportionate in its blend make-up.

It is the use of stabilizers and other mix additives such as soda (which is principally water based with low solid content) or fruit purees (that are water with higher amount of liquefied solids) that provides for the solidifying qualities necessary to hold the alcohol in suspension within the frozen individual volume of liquid while maintaining a solidified form at standard commercial and home freezer temperature ranges. The individual volume of frozen “liquid” can take many varied and different shapes as may be desired. They can be round (spherical), agglomerated (spherical or non-uniform with many stuck to each other in a type of clump), consistent or inconsistent in size and shape depending upon what is desired.

(The end result of the freezing of this composition of the prescreened invention is a solidified end product as being derived from the freezing of individual volumes of liquid.)

In order to manufacture an alcohol based frozen dessert type product a premix is required. Currently available premixes typically have the following composition:

At least 10% milk fat with some premium ice creams going as high as 16%, or even 18% in super-premium ice creams. In addition to the milk fat there is also about 9% to 12% non-fat milk solids as well as about 12% to 18% sweeteners. These sweeteners are usually a cost-optimized combination of sucrose and corn sweeteners. There is also about 2% to 5% stabilizers and emulsifiers. Alcohol content of the frozen dessert pre-mix can range from 1-10%. The desired alcohol content can be achieved by adding any liqueur flavoring known in the art including but not limited to: grain alcohol, whiskey, distilled beverages, fruit brandy distillate, brandy flavor essence, and fruit liqueurs. The remainder of the formulation, typically about 45% to 53% is water, contributed primarily by the milk.

It will be appreciated that there are numerous different recipes for alcohol based ice cream. However, to be categorized an ice cream there must be at least 10% fat contained within the composition. Other ratios typically would be 11% for non-fat milk solids, 14% for sugars, egg yolk solids 0.5% and stabilizer additives no more than 0.5% by law, and 1-10% alcohol. Many commercial ice cream manufacturers utilize dried egg yolk, powder skim milk, cane sugar, water (for reconstituting the powdered ingredients) and very inexpensive gums to produce product.

Although current low calorie, lowered sugar or no sugar added bulk pre-mixes utilize sugar replacement products to maintain desired sweetness they are formulated to create the normal freezing characteristics and low melting points of a regular bulk frozen pre-mix that has sugar added because without the presence of a bulking agent to lower the melting point of the ice cream, the product would be too hard to be served or consumed at commercial storing temperatures.

It is well known by those skilled in the art that compositions of frozen dessert products with a low concentration of sugars have a higher percentage of their water frozen at retail cabinet temperatures and are thus not as soft as products with higher concentrations of sugar at the same temperature. Since conventional bulk ice cream products require a certain degree of softness, a higher percentage of the water content of the product must remain unfrozen at retail cabinet temperatures. This can be achieved by maintaining a high level of sugar, or by adding a bulking agent which lowers the melting point of the product so that a lower percentage of the product's water is frozen at retail cabinet temperatures. Examples of known bulking agents for ice cream mixes, include but are not limited to: dextrose, fructose, sucrose, lactose, maltose, honey, and corn syrup.

In a preferred embodiment of the present invention the premix uses fresh milk and cream and stabilizers such as agar. In addition, the composition of the present invention does not require the presence of bulking agents to lower the melting point of the mix because the present invention does not require the degree of softness necessary for conventional bulk ice cream products to be scoopable at retail cabinet temperatures.

An existing infrastructure exists within the distribution system and the commercial and retail storage system to maintain frozen desserts.

In addition, an infrastructure of freezing storage equipment exists within the consumer market as well consisting of the home deep freezer as well as the freezer associated with a home refrigeration system.

A pelletized frozen dessert product is typically manufactured by introducing small volumes of a premix into a body of a cryogen such as liquid nitrogen. Historically the premix utilized for this type of pelletized frozen dessert product has utilized standard premixes utilized in bulk frozen dessert type products. The utilization of this premix demanded that the frozen pellet thus made be stored at temperatures in the range of about −34 to −40 degrees Celsius. This storage temperature demands specialized freezing equipment not generally available in the retail distribution infrastructure and in addition not available in the consumer environment. The increased storage demands of conventional pelletized frozen dessert products increase product costs because frozen dessert products are typically stored for weeks before they are completely consumed.

The storage temperatures generally encountered in the retail distribution market range as follows: Commercial retail storage is in the range of about −20 to −30 degrees Celsius. Home freezer storage in a standard deep freeze being in the range of −15 to −23 degrees Celsius. Home fridge type freezer storage in a freezer associated with a home refrigeration system being in the range of about of −6 degrees to −18 degrees Celsius.

It will be appreciated by those skilled in the art that equipment used to store ice cream operate at a plurality of temperatures, and someone of ordinary skill in the art would be able to modify the present invention so that the pellet remains frozen and in a single phase at a temperature of at least two to three degrees warmer or cooler, than the preceding temperatures listed.

In order to make this specialized unique product available to the general retail market it was essential to develop a premix that could be utilized in the manufacture of a pelletized frozen dessert product that could maintain its structural integrity within the existing freezer infrastructure for the extended period of time frozen dessert products are stored before they are served and consumed.

The development of this invention enables the pelletized frozen dessert product to be distributed and stored within the existing retail commercial infrastructure as well as within the standard home freezer storage systems of the consumer market while remaining in a single phase.

The main object of the invention is to elevate the melting temperature of the frozen pellet and for the frozen pellet to remain in a single phase at commercial storing temperatures. This melting temperature is higher than the comparable melting temperature of a bulk frozen dessert product. The elevation of the melting temperature is achieved by removing a significant percentage of the sugar or sucrose equivalents which affect the freezing point depression of the pre-mix, such as nonfat fat milk solids, whey solids, sucrose or other disaccharides, dextrose, high fructose corn syrup, in the normal premix while still retaining the preferred taste of the product. Alternatively all added sugars can be removed completely and replaced with artificial sweeteners if desired for a composition that is sugarless.

Accordingly, that significant percentage removed can range from about 30% to about 70% of the sugar normally in a premix. Thus, the sugar content of the premix of the present invention can range from 0% to 10.8%. In a preferred embodiment the sugar removed ranges from about 40% to about 60%. In a more preferred range the removed sugar can range from 45% to about 55%.

In the most preferred embodiment there is removal of about 50% of the sugar in a standard premix

Quantitatively, Raoult's law states that the solvent's vapor pressure in solution is equal to its mole fraction times its vapor pressure as a pure liquid, from which it follows that the freezing point depression and boiling point elevation are directly proportional to the molality of the solute, although the constants of proportion are different in each case.

Although Raoult's Law does predict a raising or lowering of the freezing point of a Solution subject to the alteration of its vapor pressure, this invention is in specific not an extension on this law. This is because the pellet is frozen extremely quickly and taken to a temperature well below the freezing point of any pre-mix, in an environment of a liquid cryogen. Subsequently the freezing point of the pre-mix is not a factor that is even considered.

The cryogen freezing process is an essential factor in the frozen pellet structurally existing and maintaining a single phase at the desired elevated melting temperatures. As a result of the rapid and very cold freezing of the pellet the ice crystallization is minimized and the pellet produced is a single phase product, unlike the multiple phase product of bulk frozen deserts.

The result of the rapid freezing achieved in the cryogen is a single phase pellet that is generally homogeneous in nature. The rapid freezing also results in a pellet with minimal crystallization. It is this minimal crystallization as a result of the rapid freezing that results in a pellet that has not separated into multiple phases during the freezing process as occurs in all bulk product manufactured. It is this single phase structure of the pellet that assists in its ability to stay stable at the elevated melting point of the pellet.

The elevated melting point is a direct result of the pellet structure combined with stabilizers, typically being the food grade gums added to the pre-mix which allows for the existence of a pellet that can softened because of partial melting, yet it does not flow like melting ice chips as the stabilizers/gums act to inhibit this natural action.

The invention comprises formulation alteration including the addition of food grade gums as stabilizers added to the pre-mix and subsequently processed in a liquid cryogen, such as liquid nitrogen, results in a frozen dessert pellet that meets the requirements essential for a frozen dessert pelletized product that remains stable within the existing bulk frozen dessert infrastructure.

In order to maintain consumer preferences and desired sweetness profiles the pelletized frozen dessert of the present invention preferably requires the addition of sweetness to compensate for the significant lowering of the sugar content, but have a negligible effect on the melting point of the ice cream.

This is achieved by the utilization of artificial sweeteners. Accordingly, these artificial sweeteners are preferably products such as Sucralose or Aspartame and the like.

In the preferred embodiment the sweetness level of the invention's pelletized frozen dessert product is maintained in the range of about 13% to 17% of the amount of sucrose typically present in a frozen dessert product.

In general, Sucralose provides about 600 times the sweetness in sucrose equivalency. Sucrose equivalency is a term which is generally understood by those skilled in the art as the equivalent content of sucrose in an ice cream mix based on all the mono- and di-saccharides that are present in the mix. Nonfat fat milk solids, whey solids, sucrose or other disaccharides, dextrose, high fructose corn syrup, and pure fructose are a few substances which are considered when determining sucrose equivalency.

The combination of alcohol and sucrose equivalency content should range from 1-10% in the frozen dessert product. Thus if the sucrose equivalency content is 6%, the alcohol content should be less than 4%. The Applicant has found that alcohol freezing point depression is 5.6 times the freezing point depression of sucrose. Or more simply, the addition of alcohol depresses the freezing point of the premix 5.6 times that of sucrose. The applicant has also found sucrose based freezing point depression has a factor of hydrogen bonding between the sugar and water molecules that will accelerate agglomeration in a traditional ice cream mix. When alcohol is present, the sugar content must be reduced in proportion to the alcohol content, thus reducing or inhibiting agglomeration.

The preferred embodiment is the utilization of Sucralose. The sucrose equivalency is about 1 unit of Sucralose is added to the premix for every 600 units of sucrose or any equivalent in sweetness that has been removed.

An additional embodiment is the addition of Aspartame which provides 200 times in sucrose equivalent.

The sucrose equivalency is about 1 unit of Aspartame is added to the premix for every 200 units of sucrose or any equivalent sweetness that has been removed.

There are other artificial sweeteners that are currently available or that will potentially be available in the future. Whatever their sucrose equivalence is or potentially would be would hence call for the appropriate replacement ratio to attain the desired sweetness. Current available artificial sweeteners include but are not limited to the following examples. Examples: Sucralose, Aspartame, Saccharin, Acesulfame K.

An additional embodiment is a combination of Sucralose and Aspartame in order to minimize any background disagreeable taste provided by the addition of an artificial sweetener to a food product.

Accordingly that depending upon the particular flavor of the frozen desert desired the sweetness level will vary. For example a frozen dessert product such as a vanilla ice cream pre-mix with a total sugar content of 15% to 17% of the pre-mix, an approximate replacement of about 50% of those sugars would require a sucralose replacement in the range of about 0.025% to about 0.075% depending upon sweetness preference, A preferred sucralose replacement range would be from about 0.03% to about 0.07% with a most preferred range being from about 0.04% to about 0.06%.

Accordingly a chocolate frozen product demands a higher level of sweetness to counteract the harshness of the Cocoa utilized in the mix compared to a vanilla type frozen dessert product. The chocolate frozen dessert pre-mix would hence call for a sucralose replacement of sugars in the range of about 0.075% to about 0.16% depending upon sweetness preference. A preferred sucralose replacement range would be from about 0.08% to about 0.15% with the most preferred being from about 0.09% to about 0.11%.

Accordingly, frozen dessert type products such as ice cream, sorbet, water ice, ice milk, frozen yogurt and similar type products all must be first formulated as pre-mixes with sugar replacement and stabilizer additions added prior to the cryogenic freezing process. This pre-mix formulation combined with the single phase structure of the pellet that results from the cryogenic freezing process results in being able to achieve the desired melting and fusing points necessary for compatibility with the existing frozen bulk food handling and storage infrastructure. Accordingly the sugar removal and the addition of sweetener will vary in relation to the flavor desired. The reason being that, various fruit flavors will provide an alteration in the freezing point and subsequently the melting point of the frozen pellet.

Accordingly the variances necessitate the removal of more sugar or less sugar and the relative balancing of sweetness with the artificial sweeteners. The preferred embodiment of the invention is to vary the removal of sugar or sucrose equivalents to achieve a higher melting point so that the pelletized frozen dessert product can remain in a single phase at standard commercial freezer storage temperatures, and then utilize artificial sweeteners to reestablish the desired sweetness of the pelletized frozen dessert product.

Accordingly the pellet can be served when it has become partly softened. In order to maintain its structure a stabilizer in the form of a food grade gum is added to the premix. Current stabilizer gums include but are not limited to the following examples. Examples: guar gum, carob bean gum, monodiglycerides, sodium alginate, agar. Stabilizer gum ranges for a Vanilla ice cream pre-mix depending upon the preferred texture would be from about 0.25% to about 0.60% with a preferred range from about 0.35% to about 0.55% and a most preferred range being from about 0.40% to 0.50%. For a chocolate ice cream premix the range depending upon the preferred texture would be from about 0.20% to about 0.50% with a preferred range of about 0.30% to about 0.45% and a most preferred range being from about 0.35% to about 0.44%.

Accordingly the addition of a stabilizer assists in maintaining the desired individual structure of the pellet.

Accordingly the stabilizer also inhibits fusing of the pellets when the pellet is close to the range of its melting point.

A preferred embodiment of the invention is that since the pelletized frozen dessert can now be stored at an elevated temperature the necessity of trained staff to temper the pellet to a safe temperature is not longer required.

Accordingly the safety of the pellet by avoiding potential cellular damage to the consumers mouth is achieved.

This invention of raising the freezing temperature of the premix which subsequently raises the melting point of the pelletized frozen dessert product with the subsequent addition of a stabilizer to assist in maintaining the structural integrity of the pellet when at preferred serving temperatures achieves the desired results.

The desired results being able to distribute and store a single phase alcohol based pelletized frozen dessert product within the existing infrastructure utilized for bulk frozen desserts.

In addition the raising of the storage temperature required removes the potential of cellular damage occurring in the mouth of the consumer. This removal of a serious safety concern enables the frozen pelletized dessert product to be a generally available dessert product rather than a specialized frozen dessert with expensive and cumbersome or almost impossible distribution demands.

In a preferred embodiment of the alcohol based single phase frozen product of the present invention there is preferably no sucrose and the sweetness is provided by an artificial sweetener. The total alcohol content of such product does not exceed about 8%. Thus for example, a drink such as a Rum and Coke where there are no solids in the premix there is no sugar. The Coke in the formulation is Diet Coke and the sweetness is provided by the Diet Coke not by sucrose or other sugar. The alcohol content of the formulation is preferably about 8% or less and the balance is primarily water. The same is true for other alcohol based drinks that do not have any solids therein such as gin and tonic, scotch and soda, rye and ginger etc. For drinks that have a solids component the alcohol content still preferably does not exceed about 8%. The balance is solids and water. For example, in a strawberry daiquiri the composition would be about 8% alcohol, strawberry puree, an artificial sweetener and the balance water. There would preferably be no sucrose in the composition.

For a frozen dessert product containing alcohol the total alcohol and sucrose equivalency of the composition should not exceed 10%. Sucrose equivalency is defined by ICE CREAM, by Marshall, Goff and Hartel (6^{th} Edition, 2003) which is a leading book on the making of ice cream. Sucrose equivalency is defined as the equivalent content of sucrose in an ice cream mix based on all the mono- and di-saccharides that are present in the mix. See page 140 paragraph 3. These sucrose equivalents can include nonfat fat milk solids, whey solids, sucrose or other disaccharides, dextrose, high fructose corn syrup, and pure fructose and others. Seepage 140 paragraph 3. In these compositions the alcohol content can be as high as 10% provided there is no sucrose equivalent in the composition. As used herein in this application the percentages are the weight percents of the materials.

### TEST EXAMPLE

Next, the effects of the present invention will be described by the following Test Example.

### Test Example

This test example was used to determine the temperature at which the present invention no longer remains in a single phase.

### (1) Preparation of Samples

A container with a volume of one pint filled was filled with the single phased frozen dessert product of the present invention.

### (2) Method of the Test

The container was kept at approximately 21° C. It was stirred occasionally to keep a more uniform temperature throughout the product. The temperature of the frozen dessert product was recorded at regular intervals and the frozen desert product was visually inspected to determine if a phase change had taken place.

### (3) Results of the Test

The frozen dessert product began the experiment at a temperature of −19° C. and in a single solid phase. As the temperature of the pellets increased, the present product remained in a single phase until it reached a temperature of −5° C. and 60 minutes had elapsed. When the product reached a temperature of −3° C. it was mostly melted and liquid.

### (4) Data

| Time | Temperature | Observation |
|---|---|---|
| start | −19° C. | solid |
| | | flowing, solid |
| +20 min | −17° C. | solid |
| | | flowing, solid |
| +30 min | −13° C. | solid |
| | | flowing, solid |
| +40 min | −9° C. | solid |
| | | flowing, solid |
| +50 min | −8° C. | starting to soften |
| +60 minutes | −5° C. | starting to melt and slight |
| | | agglomeration |
| +75 minutes | −3° C. | melted and mostly liquid |

What is claimed is:

1. A frozen dessert product comprising a single phase pellet said single phase being a solid phase, said pellet consisting essentially of a premix comprising about 6% to 7.5% sucrose equivalency, and 0.025% to about 0.075% artificial sweetener, and about 4% to 2.5% alcohol, said pellet resulting from said premix being introduced into a cryogen as a small individual volume of liquid, then completely freezing, said pellet remaining in a pellet form at a temperature of from about −25° C. to about −5° C.

2. A method of forming a single phase dessert product, the method comprising the steps of:
introducing a premix into a body of liquid cryogen as a small individual volume of liquid to form a single phase pelletized dessert product wherein said pelletized dessert product consists of a premix without the presence of a bulking agent;
said small individual volume of liquid completely freezing after it is introduced to said body of liquid cryogen to form a solid phase pellet consisting essentially of premix;
said premix comprising an artificial sweetener in the amount of about 0.025% to about 0.075% of the premix; about 2-5% alcohol and
further wherein the single phase dessert product, can be stored at a temperature of from about −25° C. to about −5° C. while remaining in a solid phase.

3. The frozen dessert product according to claim 1 wherein said pellet does not fuse to another pellet while said pellets remain a single phase product.

4. The frozen dessert product of claim 1 wherein said pellet consists of premix without the presence of a bulking agent.

5. The frozen dessert product according to claim 1 wherein said single phase pellet remains frozen at a temperature of about −18° C. to about −20° C.

6. The frozen dessert product according to claim 1 wherein said single phase pellet remains frozen at a temperature of about −15° C. to about −18° C.

7. A frozen dessert product comprising a single phase pellet said single phase being a solid phase, said pellet consisting essentially of a premix comprising about 7% to about 9.5% sucrose equivalency, and about 0.025% to about 0.075% artificial sweetener, and about 3% to about 0.5% alcohol, said pellet resulting from said premix being introduced into a cryogen as a small individual volume of liquid, then completely freezing, said pellet remaining in a pellet form at a temperature of from about −25° C. to about −5° C. without fusing to another pellet.

8. A method of forming a single phase dessert product, the method comprising the steps of:
introducing a premix into a body of liquid cryogen as a small individual volume of liquid to form a single phase pelletized dessert product wherein said pelletized dessert product consists of a premix without the presence of a bulking agent;
said small individual volume of liquid completely freezing after it is introduced to said body of liquid cryogen to form a solid phase pellet consisting essentially of premix;
said premix comprising an artificial sweetener in the amount of about 0.025% to about 0.075% of the premix; about 4-8% alcohol and
further wherein the single phase dessert product, can be stored at a temperature of from about −25° C. to about −5° C. while remaining in a solid phase.

9. The method of claim 2, wherein the premix further comprises a sucrose or sucrose equivalent content of about 6.0% to 7.5% of the premix.

10. The method of claim 2, wherein the sweetener is sucrose or a corn sweetener.

11. The method of claim 2, wherein the artificial sweetener is sucralose, aspartame, saccharin, acesulphame K and combinations thereof.

12. The method of claim 2, wherein the dessert product is ice cream, sorbet, sherbet, water ice, ice milk or frozen yogurt.

13. A frozen dessert product comprising a single phase pellet formed from a premix comprising from about 3.6% to about 7.2% sugar and 1.4% to 2.8% alcohol, said pellet resulting from said premix being introduced into a cryogen, said pellet consisting essentially of pre-mix and remaining a single phase solid product at a temperature of from between about −15 and about −25 degrees Celsius without fusing to another pellet of similar composition.

14. A frozen dessert product comprising a single phase pellet formed from a premix, said premix containing no bulking agents, said premix comprising from about 7.5% to 8.5% total sucrose and sucrose equivalent content and about 1.5% to about 2.5% alcohol said pellet resulting from said premix being introduced into a cryogen, said pellet consisting essentially of pre-mix and remaining a single phase product at a temperature of about −25 degrees Celsius to about −5 degrees Celsius without fusing to another pellet of similar composition.

15. A frozen dessert product comprising a single phase pellet formed from a premix, said premix containing between about 1 to 10% alcohol, said pellet resulting from said premix being introduced into a cryogen, said pellet consisting essentially of pre-mix and remaining a single phase product at a temperature of about −25 degrees Celsius to about −5 degrees Celsius without agglomerating with adjacent pellets of similar composition.

16. The frozen product according to claim 15 wherein the product can be stored at a temperature of about −25° C. to −20° C. without agglomerating with adjacent pellets.

17. The frozen product according to claim 15 wherein the product can be stored at a temperature of about −20° C. to −10° C. without agglomerating with adjacent pellets of similar composition.

18. A frozen drink product comprising a single phase pellets formed from a premix, said premix containing an alcohol content making said frozen drink up to about 20 proof; said pellet resulting from said premix being introduced into a cryogen, said pellet consisting essentially of pre-mix and remaining a single phase product at a temperature of about −25 degrees Celsius to about −5 degrees Celsius without fusing to another pellet of similar composition.

19. A frozen drink product according to claim 18 wherein said single phase pellets have an alcohol content up to 18 proof.

20. A frozen drink product according to claim 18 wherein said single phase pellets have an alcohol content up to 16 proof.

21. A frozen drink product according to claim 18 wherein said single phase pellets have an alcohol content up to 14 proof.

22. A frozen drink product according to claim 18 wherein said single phase pellets have an alcohol content up to 12 proof.

23. A frozen drink product according to claim 18 wherein said single phase pellets have an alcohol content up to 10 proof.

24. A frozen drink product according to claim 18 wherein said single phase pellets have an alcohol content up to 8 proof.

25. A frozen drink product according to claim 18 wherein said single phase pellets have an alcohol content up to 6 proof.

26. A frozen drink product according to claim 18 wherein said single phase pellets have an alcohol content up to 4 proof.

27. A frozen drink product according to claim 18 wherein said single phase pellets have an alcohol content up to 2 proof.

28. A frozen drink product according to claim 18 wherein said single phase pellets have an alcohol content of from 2 proof to 20 proof.

29. A frozen drink product according to claim 18 wherein said single phase pellets have an alcohol content from 2 proof to 10 proof.
